(19) United States
(12) Patent Application Publication
(10) Pub. No.: US 2008/0157039 A1
(43) Pub. Date: Jul. 3, 2008

(54) Nano-polymeric encapsulation of a key reactant to control chemo-fluorescent active reaction period for chemiluminescent paint

(76) Inventor: Matthew Mark Zuckerman, Woody Creek, CO (US)

Correspondence Address: GEORGE S. COLE, ESQ., 495 SEAPORT COURT, SUITE 101, REDWOOD CITY, CA, 94063, US

(21) Appl. No.: 11/648,024

(22) Filed: Dec. 30, 2006

(51) Int. Cl. C09D 5/22

(52) U.S. Cl. 252/700

(57) ABSTRACT

The present invention is a method for making a chemiluminescent paint whose chemo-fluorescent reaction's active period is controllable as a first-order function of humidity, thus reducing to a second order function the prior art's dependency on ambient temperature, through encapsulating a key reactant in a moisture-sensitive, nano-polymeric structure and combining that encapsulating structure and encapsulated reactant with the other elements necessary for both the excitative and fluorescing reactions of the chemiluminescent paint.

### BACKGROUND OF THE INVENTION

Chemiluminescence is the production of light from a non-heat-generating chemical reaction; in short, light without fire. The firefly's biochemical chemiluminescent reaction is highly efficient, approaching the theoretical limit of one photon produced for each molecule involved in the reaction, producing 88 photons for each 100 molecules for a yield of 88%. The current man-made chemiluminescence uses chemical reactions that require a fluorescent molecule, a key intermediate, and a catalyst; and produce sustainable, instantaneous, highly visible light, which specific doping can allow differing colors and intensities. Commercially valuable, man-made chemiluminescent reactions have efficiencies as high as 23%, which is far less than the 88% efficiency of the firefly.

Man-made chemiluminescence combines two kinds of chemistry. First is fluorescence. Chemiluminescence includes the fluorescent process as a product of a chemical reaction (as opposed to photonic absorption and re-emission). The second type of chemistry is what (when mixed with the fluorescer) actually produces the excited state. This excitation process is the heart of chemiluminescence. Certain decomposition reactions of organic peroxides are currently used to produce excited products with the described limited efficiency.

The excitation process must generate at least 40 to 70 kilocalories/mole of energy to reach the energy range of visible light. This is a substantial amount of energy in chemical terms; only highly energetic molecules meet this requirement. Furthermore this energy must both be available, and must be provided in a single chemical step, essentially instantaneously. Just as in an incandescent light bulb, atoms in the materials are excited, causing electrons to rise to a higher and then return to a normal energy level. When the electrons return to their normal levels, they release energy as light.

Rauhut and Laszlo J. Bollyky developed a series of oxalate esters and produced the first commercial chemiluminescent reaction with a quantum yield of 5%. Hardly as efficient as a firefly, but still useful. Rauhut designed a phenyl oxalate ester that when mixed with hydrogen peroxide and a dye produced light, as shown by FIG. 1, below.

The mechanism is that first the phenyl oxalate ester and hydrogen peroxide (H₂O₂) react in the presence of a salicylate catalyst forming a peroxy acid ester and phenol; and then the peroxy acid ester decomposes to form more phenol and a highly energetic intermediate, presumed to be a cyclic compound containing four-membered ring dimer of CO₂. As the cyclic dimer decomposes into two CO₂ molecules, it gives up its energy to a waiting dye molecule, which then fluoresces.

The chemical reaction taking place includes a solution of a phenyl oxalate ester (commonly bis(2,4,5-trichlorophenyl-6-carbopentoxyphenyl)oxalate (CPPO), a fluorescent dye that determines the color of light, and hydrogen peroxide. The hydrogen peroxide (H₂O₂) is separated from the other two chemicals until chemiluminescence is desired, when they are combined. Then the hydrogen peroxide reacts with the phenyl oxalate ester producing carbon dioxide, a phenol and, most importantly, releasing energy. This energy is absorbed by the dye, exciting electrons in the dye's molecules to a higher energy level. Once at the higher energy level, the electrons immediately lose the energy they absorbed and fall to lower energy levels. As the electrons fall back to lower energy levels, the energy that is lost is transformed into electromagnetic radiation, some of which is visible light.

The dye must gain energy from the breakdown of the CPPO. For light to be seen in the visible spectrum, the radiation emitted must be between 400 nm and 700 nm. This range of wavelengths has a corresponding range of energy required between 170 kJ/mol and 300 kJ/mol. This energy is released from a high energy intermediate that forms during the reaction and is transferred to the dye. The intermediate that forms when the CPPO is oxidized by hydrogen peroxide is called 1,2-dioxetane-3,4-dione. This compound is a four membered ring structure. As in most four membered rings, the compound is considered high in energy because of the strain on the bonds of the molecule forcing them into the ring. Although the compounds are different, they all share the common trait of being highly conjugated systems. This conjugation allows electrons to move easily because of the small gap between the highest occupied molecular orbital (HOMO) and the lowest unoccupied molecular orbital (LUMO). The energy produced as the four-membered ring structure decomposes into two CO₂ molecules is enough to move the electrons across the gap.

Because the fluorescer is separate from the energy-producing components of the reaction, it can be varied without changing the basic chemistry. Since the color of the light depends on the fluorescer selected, peroxyoxalate chemiluminescence can be formulated in many desired colors. Blue color can be produced using 9,10 diphenylanthracene, green color can be produced using 9,10-bis(phenylethynyl)anthracene, yellow can be produced using either of 1-chloro-9,10-bis(phenylethynyl)anthracene or Rubrene [5,6,11,12-tetraphenylnaphthacene], orange can be produced using 5,12-bis(phenylethynyl)-napthacene and red can be produced using Rhodamine B. However, Rhodamine B is rarely used because it will break down when mixed with the phenyl oxalate ester and shorten the shelf life of the product.

Once the reaction has been activated, it cannot be stopped until the reaction is complete. Under normal conditions when sufficient materials are present the reaction will emit light for hours before running its course. After the reaction has been initiated, reducing the temperature will extend the life into days. The cold temperatures cause the reaction rate to slow down drastically. Raising the temperature affects the rate of the reaction. It causes the rate to increase and the light that is emitted more intense and last for only tens of minutes.

Omniglow, which produces a line of chemiluminescent light sticks (for emergency use when power is not available) and novelty items, uses the preparation described immediately below for the oxalate and the peroxide component for chemiluminescent light sticks, achieving a reaction efficiency of 17%.
a. Preparation of the oxalate component: Dissolve 67.5 g of bis(6-carbopentoxy-2,4,5-trichlorophenyl)oxalate in 1 L dibutyl phthalate and heat the solution at 150 degree C. for 1 hour under nitrogen atmosphere. Then cooled the solution to 100 degree C. and added 1.9 g of dye [9,10-bis(phenylethynyl)anthracene]. After completion cool the solution to room temperature.
b. Preparation of the peroxide component: Mix and stir 750 mL of dimethyl phthalate, 220 mL of t-butyl alcohol and 0.5 g of sodium salicylate at room temperature for 1 h. Then slowly added 53 g of 98% hydrogen peroxide into the mixture and again stirred at room temperature for 1 hour.

### DESCRIPTION OF THE DRAWINGS

FIG. 1, incorporated in the text, shows the chemical reaction that produces chemiluminescence.

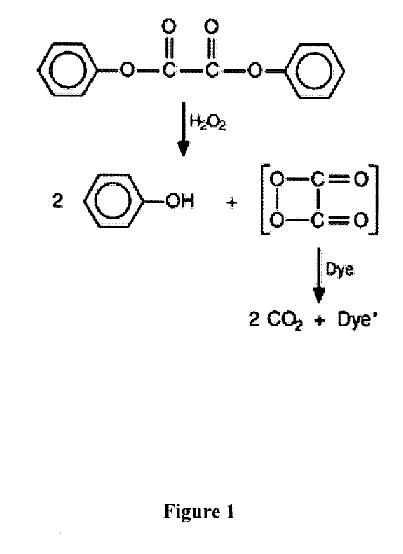

FIG. 2 shows the main steps of the method: choosing the reactant, solvent, catalyst, & dye (fluorescer) [1]; selecting the activating ingredient from reactant, solvent, catalyst, and dye [2]; encapsulating the activating ingredient in a nano-polymeric structure that will be hydrolized by ambient moisture [3]; and incorporating the encapsulated activating ingredient and the non-encapsulated other ingredients in a base paint [4].

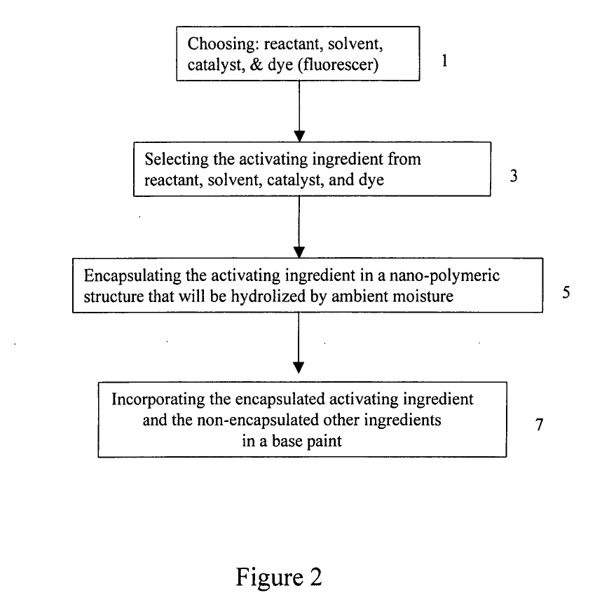

FIG. 3 shows the use of separate containers for the activating ingredient [10] and the other ingredients [12] and of a y-shaped nozzle [14] to join the ingredients and thus start the hydrolizing and reactive process as the paint [16] is applied to a surface [18].

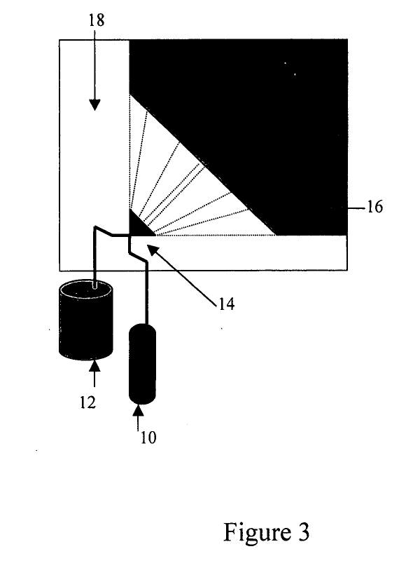

### SUMMARY OF THE INVENTION

The invention is a method for controlling the rate at which a chemiluminescence reaction takes place by encapsulating a key reactant in a moisture-sensitive, nano-polymeric structure which has an average particle diameter of about from 10 nanometers (0.01 micron) to 1000 nanometers (1 micron). By producing a paint that incorporates a reactant, a solvent, a catalyst, and a dye, wherein one or any combination of these ingredients is encapsulated in moisture-sensitive, nano-polymeric structures with progressive sensitivity, then by controlling the humidity or, for a given humidity, the degree of sensitivity of the moisture-sensitive, nano-polymeric structures, the necessary excitation and fluorescing reactions can be made controllable through a first-order responsiveness to the ambient humidity rather than the ambient temperature.

In a chemiluminescent paint, a combination of the reactant of phenyl oxalate ester and the solvent of hydrogen peroxide (H₂O₂) will react in the presence of the catalyst of sodium salicylate to form a peroxy acid ester and phenol in Step One of the chemiluminescent reaction as follows:

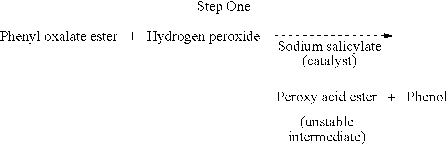

The completion of the chemiluminescence reaction to florescence is accomplished in Step Two, when the intermediate product of peroxy acid ester first decomposes to form more phenol and a highly energetic intermediate, presumed to be a cyclic compound containing four-membered ring dimer of CO₂. Then, as the cyclic dimer decomposes into two CO₂ molecules, it gives up its energy to a waiting dye molecule, which then fluoresces.

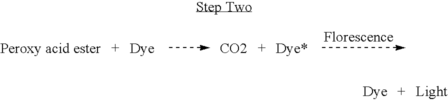

In a first instantiation of the invention, the solvent, typically hydrogen peroxide (H₂O₂), is encapsulated.

In a second instantiation of the invention, the catalyst, typically sodium salicylate, is encapsulated.

In a third instantiation of the invention, the reactant, typically phenyl oxalate ester, is encapsulated.

In a fourth instantiation of the invention, some combination of the proportions of the separate components, the solvent, typically hydrogen peroxide (H₂O₂), the catalyst, typically sodium salicylate, and the reactant, typically phenyl oxalate ester, are each encapsulated.

In a fifth instantiation the salicylate is used in the cationic form as sodium salicylate for the catalyst.

The best method uses a formulation of reactant phenyl oxalate ester 50 mg, catalyst of sodium salicylate in a range from 5 to and including 10 g, the dye of 10 mg, and solvent 5 to 10 ml of hydrogen peroxide of 3 to 5% by weight hydrogen peroxide.

### DETAILED DESCRIPTION OF THE INVENTION

The present invention uses moisture-sensitive nano-polymeric structures and materials combined with chemiluminescence and excitation reactions for florescence paint to produce the unexpected result of reducing the dependence of the life of the actively fluorescing (chemiluminescent) paint on ambient temperature.

According to a feature of the invention the activating ingredient for the chemo-fluorescent reaction is encapsulated into progressive nano-polymeric structures. This nano-polymeric structure uses humidity to control duration of the reaction, by progressively releasing the activating ingredient on exposure to humidity over time.

According to another feature of the invention a dual-aerosol, spray-can system is used to store and apply chemo-fluorescent marking paint with one aerosol stream containing the encapsulated activating ingredient and the other containing the other chemical reactants, wherein the contents of the two streams are mixed just prior to applying the chemo-fluorescent marking paint, thereby only beginning the chemiluminescence upon mixture and application of the two streams.

According to still another feature of the invention the full progression of the chemo-fluorescent reaction to completion and the cessation of chemiluminescence in a shortened time in accordance with an external, intended act, is enabled by using the moisture-sensitive nano-polymeric structures and materials combined with chemiluminescence and excitation reactions for florescence paint that has a neutral, background, or transparent color value in the absence of chemiluminescence, by spraying water on the surface marked by the actively fluorescing (chemiluminescent) paint.

Varying the degree of encapsulation of the polymeric structure is well known in the current art, as can be seen in the general-market ads for ‘micro-encapsulated’ over-the-counter medications (also known as timed-release medications). The preferred method uses a ozokerite silicon copolymer, whose nano-polymeric structure has an average particle diameter of about from 10 nanometers (0.01 micron) to 1000 nanometers (1 micron).

In an instantiation of the invention the paint incorporates structures with a progressive range of relative volumes devoted to structure and contents. Incorporating a combination of structures with progressive encapsulation allows for limited reaction intensity, controlling it differentially through varying the amount of the reactant, solvent, and catalyst as the humidity gradually terminates the encapsulation of the activating ingredient. The lifespan is a function of the amount of moisture present rather than temperature in the instant invention because the encapsulation unwinds in a time-moisture concentration relationship. Therefore the selection of the encapsulation material used can be tailored to the expectation of the relative humidity present to obtain the life of the light. For use in arid climates where the relative humidity is say 20% it is necessary to select an encapsulation material more sensitive to moisture then for use in a tropical climate with say 80% humidity to get the same desired life.

This method allows the production of a chemiluminescent paint that can have a more controllable time period. Under ordinary circumstances, at standard humidity ranges, the chemiluminescent period may be tens of hours as the chemicals combine once released. But if a shortened period is desired—after an accident scene has been investigated, or after power has been restored—this period can be accelerated and shortened to its limit by simply washing the paint with water (thereby increasing the humidity locally to 100%).

Contrariwise, the storage period can be extended, by using separate containers for the chemicals that are to be combined, and only starting the excitation and fluorescent reactions when the streams of the encapsulated and non-encapsulated chemicals (reactant, solvent, and catalyst) are combined. One of the current problems with the existing art is the need to produce containers with frangible separating portions that must not break before the chemiluminescent reaction is to begin, yet must also be readily breakable (often by weak, ill, or young individuals with less than adult strength or physical capability). If improperly moved or stored—such that the containers are unduly jostled or even just shaken—the separating walls may break, allowing the chemiluminescence to begin. This can be particularly troublesome when an emergency light source is reached for when an emergency arrives, only to find that a minor upset sometime in the past has already exhausted the chemical reactant's capability to produce the chemiluminescence. As a further instantiation of the invention, various methods for preparing the oxalate and peroxide components is further described in the following paragraphs. The best glow result may be obtained by mixing the oxalate and peroxide components in 1:3 ratios.

In a first embodiment, wherein the preferable concentration of hydrogen peroxide is 1.6M, the oxalate component and peroxide components are respectively prepared as follows.

### A. Preparation of Oxalate Component

Place bis(6-carbopentoxy-2,4,5-trichlorophenyl)oxalate and dibutyl phthalate in a 1-liter 3-neck flask fitted with N₂ inlet, a stirrer, and thermometer. Dissolve the oxalate by stirring the solution at 150° C. for 1 hour under N₂ atmosphere. Then cool the solution to 100° C. and add a suitable fluorescer. Finally cool the solution to room temperature before mixing with peroxide component. The preferable concentration of the oxalate ester is 0.1M and the fluorescer is 0.005M.

### B. Preparation of Peroxide Component

Place dimethyl phthalate, t-butyl alcohol and sodium salicylate in a 500 mL flask fitted with a stirrer. Stir the solution at room temperature for 1 hour and then slowly add 3 to 5 wt. % hydrogen peroxide solution (based on the weight of the oxalate component) into the mixture and again stir at room temperature for 1 hour.

In a further embodiment, while the peroxide component is prepared using the procedure described immediately above, the oxalate component is prepared by choosing a solvent that will dissolve the oxalate ester at room temperature. The advantage of using a solvent to dissolve the oxalate ester at room temperature is the potential it provides for large-scale production in a short period of time with resulting lower cost.

### C. Preparation of Oxalate Component

Mix bis(6-carbopentoxy-2,4,5-trichlorophenyl)oxalate and dipropylene glycol dimethyl ether (solvent) under N₂ atmosphere followed by the addition of desired fluorescer. Only 5 minutes of stirring at room temperature required for mixing the oxalate and fluorescer.

In yet a further embodiment increasing the chemiluminescent efficiency is obtained by, immediately after mixing the oxalate and peroxide precursors, encapsulating the activating ingredient or the dye fluorescer with nano-polymeric compounds. This is done not just to control the rate of chemiluminescent reaction but also to

In a further embodiment, immediately after mixing oxalate and peroxide precursors, the reaction mixture (being any of the key reactants and chemiluminescent liquid) is encapsulated with at least one nano-polymeric compound to control the rate of chemiluminescent reaction, to increase the chemiluminescence efficiency.

In a further embodiment, additional material is chosen and added to enhance the reflective light intensity of the paint. Gold or silver nanoparticles can be used to enhance the perceived intensity of the chemiluminescence reaction, increasing the emitted light intensity linearly with an increasing concentration of the gold or silver nanoparticles. In this method, a colloidal form of gold or silver nanoparticles, each nanoparticle averaging less than 40 nm size in any dimension, is mixed with desired fluorescer. The internal reflectivity and thus total emitted light from the paint will increase through the provision of these incorporated nano-reflectors.

The scope of this invention includes any combination of the steps from the different embodiments disclosed in this specification, and is not limited to the specifics of the preferred embodiment or any of the alternative embodiments mentioned above. Individual embodiments of this invention may contain all, or less than all, of the steps disclosed in the specification. The claims stated herein should be read as including those steps which are not necessary to the invention yet are in the prior art and are necessary to the overall function of that particular claim, and should be read as including, to the maximum extent permissible by law, known functional equivalents to the steps disclosed in the specification, even though those functional equivalents are not exhaustively detailed herein.

I claim:

1. A method of manufacture of a chemo-fluorescent paint that exhibits chemiluminescence controlled by ambient conditions of humidity rather than temperature, comprising:
choosing as the ingredients for producing chemiluminescence a reactant, a solvent, a catalyst, and a dye, that when combined will undergo both excitation and fluorescent reactions;
selecting at least one of the reactant, solvent, catalyst, and die as an activating ingredient;
encapsulating the activating ingredient in a nano-polymeric structure that will release the activating ingredient as the nano-polymeric structure is hydrolyzed by ambient moisture after the chemo-fluorescent paint is applied to a surface;
incorporating both the remaining, non-encapsulated, ingredients and the activating ingredient after encapsulating it into a base paint that will, upon application to a surface and consequent exposure to humidity, combine the encapsulated activating ingredient with the other non-encapsulated ingredients thereby creating excitation and fluorescent reactions such that the chemo-fluorescent paint will exhibit chemiluminescence.

2. A method as in claim 1 wherein the reactant is a phenyl oxalate ester, the solvent is hydrogen peroxide, the catalyst is a salicylate, and the dye is a fluorescer.

3. The method as set forth in claim 2 wherein the phenyl oxalate ester is bis(2,4,5-trichlorophenyl-6-carbopentoxyphenyl)oxalate, the catalyst is a sodium salicylate, the nano-polymeric structure used in the encapsulation is ozokerite silicon copolymer having an average particle diameter ranging from 10 nanometers (0.01 micron) through to 1000 nanometers (1 micron), the solvent is hydrogen peroxide; and the fluorescer is 1-chloro-9,10-bis(phenylethynyl)anthracene yielding a yellow light.

4. The method as set forth in claim 2 wherein the phenyl oxalate ester is chosen from a population comprising the following chemicals:
bis(2,4,6-trichlorophenyl)oxalate (TCPO),
bis(6-carbopentoxy-2,4,5-trichlorophenyl)oxalate (CPPO),
bis(2,4,5-trichloro-6-carbobutoxyphenyl)oxalate,
bis(2,4,5-tribromo-6-carbohexoxyphenyl)oxalate, and
bis(2,4-dinitrophenyl)oxalate.

5. The method as set forth in claim 2 wherein the solvent is chosen from a population comprising the following chemical combinations:
dimethyl phthalate+t-butyl alcohol;
dibutyl phthalate, bis(2-ethylhexyl)phthalate+t-butyl alcohol;
acetyl tributyl citrate; and,
ethylacetate (80%)+acetonitrile (20%), tetrahydrofuran, and dimethylsulfoxide.

6. The method as set forth in claim 2 wherein the phenyl oxalate ester is Luminal, 3-aminophthalhydrazide, producing light without the addition of a dye.

7. The method as set forth in claim 6 wherein potassium ferrycyamide is added to create green light.

8. The method as set forth in claim 6 wherein copper pentahydrate is added to create blue light.

9. The method as set forth in claim 2, further combining the reactant, solvent, and catalyst in the following proportions without considering the weight and/or volume of the encapsulating nano-polymeric structure or base paint: 50 mg of Phenyl oxalate ester, a range from 5 through to 10 g of catalyst, 10 mg of dye, and a range from 5 to 10 ml of hydrogen peroxide solution of 3 to 5% by weight hydrogen peroxide.

10. The method as set forth in claim 2 further comprising:
separating during storage into a first container the encapsulated activating ingredient and into a second container the non-encapsulated ingredients;
joining the first container and second container with a common spray nozzle; and,
spraying and mixing the activating ingredient and non-activating ingredients from and through the common spray nozzle.

11. The method as set forth in claim 1 wherein the dye selected is 9,10-diphenylanthracene yielding blue color or 9,10-bis(phenylethynyl)anthracene yielding a green color or 1-chloro-9,10-bis(phenylethynyl)anthracene yielding a yellow color or Rubrene (5,6,11,12-tetraphenylnaphthacene) or 5,12-bis(phenylethynyl)-napthacene yielding an orange color or Rhodamine B yielding a red color.

12. The method as set forth in claim 1 wherein the nano-polymeric structure that releases the activating ingredient as the nano-polymeric structure is hydrolyzed by the ambient moisture is a ozokerite silicon copolymer that has an average particle diameter ranging from 10 nanometers (0.01 micron) through to 1000 nanometers (1 micron).

13. A temporarily chemiluminescent marking paint in fluorescent color created using the method of claim 2, wherein the humidity in air is the primary control of the life of the product and the rate of disappearance of the marking can be accelerated by spraying water onto the paint.

14. A method as in claim 4 further comprising:
preparing the oxalate component as follows:
placing bis(6-carbopentoxy-2,4,5-trichlorophenyl)oxalate and dibutyl phthalate in a solution in a 1-liter 3-neck flask fitted with an N₂ inlet, a stirrer, and thermometer;
dissolving the bis(6-carbopentoxy-2,4,5-trichlorophenyl)oxalate by stirring the solution at 150° C. for 1 hour under an N₂ atmosphere;
then cooling the solution to 100° C.;
then adding the dye that is to be a fluorescer;
cooling the solution to room temperature; and only then,
mixing in the solvent peroxide component;
wherein the concentration of the oxalate ester is 0.1M and the concentration of the fluorescer is 0.005M; and,
preparing the peroxide component as follows:
placing the dimethyl phthalate, t-butyl alcohol and sodium salicylate in a solution in a 500 mL flask fitted with a stirrer;
stirring the solution at room temperature for 1 hour;
then slowly adding into the solution a hydrogen peroxide solution whose total weight will amount to a range of 3 to 5 percent of the weight of the oxalate component; and,
again stirring the solution at room temperature for 1 hour;
wherein the preferable concentration of hydrogen peroxide is 1.6M.

15. A method as in claim 4 further comprising:
preparing the oxalate component as follows:
mixing bis(6-carbopentoxy-2,4,5-trichlorophenyl)oxalate and dipropylene glycol dimethyl ether as the solvent under N₂ atmosphere;
followed by adding the dye; and,
stirring for up to five minutes at room temperature to mix the oxalate and dye;
preparing the peroxide component as follows:
placing the dimethyl phthalate, t-butyl alcohol and sodium salicylate in a solution in a 500 mL flask fitted with a stirrer;
stirring the solution at room temperature for 1 hour;
then slowly adding into the solution a hydrogen peroxide solution whose total weight will amount to a range of 3 to 5 percent of the weight of the oxalate component; and,
again stirring the solution at room temperature for 1 hour;
wherein the preferable concentration of hydrogen peroxide is 1.6M;
wherein the oxalate component and peroxide component are mixed in a ratio of 1:3.

16. A method as in claim 2 further comprising:
immediately after mixing the reactant and solvent, encapsulating the activating ingredient; and,
coating the encapsulated activating ingredient with one of a set of nano-polymeric reflective surfaces and metal nanoparticles with a size of less than 40 nm.

17. A method as in claim 16 further comprising using as the metal nanoparticle one of a set of gold and silver.

18. A method as in claim 2 further comprising mixing with the fluorescer a colloidal form of one of a set of gold and silver metal nanoparticles, each nanoparticle averaging less than 40 nm size in any dimension, to enhance the reflective light intensity of the paint.
